(19) United States
(12) Patent Application Publication
(10) Pub. No.: US 2012/0030289 A1
(43) Pub. Date: Feb. 2, 2012

(54) SYSTEM AND METHOD FOR MULTI-MODEL, CONTEXT-SENSITIVE, REAL-TIME COLLABORATION

(75) Inventors: John F. BUFORD, Princeton, NJ (US); Krishna K. Dhara, Dayton, NJ (US); Mario Kolberg, Glasgow (GB); Venkatesh Krishnaswamy, Holmdel, NJ (US); Xiaotao Wu, Metuchen, NJ (US)

(73) Assignee: Avaya Inc., Basking Ridge, NJ (US)

(21) Appl. No.: 12/848,009

(22) Filed: Jul. 30, 2010

(51) Int. Cl. G06F 15/16

(52) U.S. Cl. 709/205

(57) ABSTRACT

Disclosed herein are systems, methods, and non-transitory computer-readable storage media for communicating via a multi-model collaboration space. A system practicing the method first assigns a communication endpoint identifier to a multi-model collaboration space having at least one entity. The endpoint identifier can be a telephone, email address, IP address, or username, for example. The system receives an incoming communication addressed to the communication endpoint identifier, such as a telephone call or email, and transfers the incoming communication to at least one entity in the multi-model collaboration space. In one aspect, the multi-model collaboration space provides a shared persistent container where entities can perform collaboration activities. The entities can have unique identities. The entities can be humans and/or automated, non-human, system-owned entities. Entities can share their context-specific view of the multi-model collaboration space with other entities. Such a multi-model collaboration space can be used in an enterprise environment.

### BACKGROUND

1. Technical Field

The present disclosure relates to collaborative communications and more specifically to individually addressable collaboration spaces.

2. Introduction

Existing collaboration platforms vary from wikis, blogs, and shared documents to web-based collaboration systems to 3D collaboration spaces offered by virtual worlds. While wilds and blogs are used as collaborative authoring tools for a large number of users, other web-based conferencing systems are used to create a space that combines users' communication links with desktop application sharing. Typically, these include audio and video conferencing and features such as sidebar, remote-party mute, etc. These systems are based on the notion that there is a common space that is accessed through a browser and users can collaborate in that space.

Microsoft Groove and SharePoint offer an alternate approach for collaboration on a set of files or documents. The collaboration client is a thick application and not a generic, browser-based client. Besides the client, one major variation of this approach is the individual view of data until it is synchronized. That is, each user in the collaboration session can have their view of the data that they work on remotely and synchronize through various means to a common repository. This synchronization is enabled in the client by providing tools for communication between users and by displaying the presence status of various users that belong to the collaboration session.

Other new collaboration platforms such as Google Wave and Thinkature offer real-time collaboration tools that allow users to create and manage their own collaboration spaces. The ability to create a collaboration space allows users to tailor collaboration spaces to the needs of a project or for a particular collaborative effort. The persistence of these spaces allows users to continue a collaboration in a given space and continue to use part or all of the contacts, contents, and other tools previously added to the space. Further, Google Wave allows threading of a collaborative effort as a Wave and allows user-defined applications (gadgets) and automated participants (robots) to act on such waves. These approaches are each lacking integration and/or other features which are useful or required for enterprise collaboration.

Another set of collaboration platforms is based on virtual worlds, such as Second Life, Kaneva, and There.com. These virtual words offer features such as immediacy (real-time interaction), interaction (ability to view, create, modify, and act) on a shared space that is closer to replicating reality. While these platforms offer rich user experiences, often the creation of collaboration spaces and the navigation in those spaces is not easy. All of these efforts improve communication and interaction among users of virtual worlds, but are limited to instant messaging or in-world voice.

These existing approaches have several limitations. For example, each of these approaches is a closed single model, provides only limited integration of real-time enterprise communications, does not enable context sensitive views to participants to be presented in real-time to each participant, cannot easily reference activities in the collaboration space with other collaborations, and the history of the collaboration is not easily navigatable or re-usable for subsequent similar collaborations, if such a history is stored at all.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The approaches set forth herein provide for collaboration via a common multi-model workspace. A multi-model collaboration workspace can include user-specific personal views of the collaboration workspace. Personal views can include materials that assist individual users in the collaboration space. Existing online collaboration tools and platforms provide basic communications integration and the ability to include some real-time information sources. For enterprise use there are requirements for extending these tools with better integration with existing intelligent communication systems, simplifying the collaboration life cycle, enabling the collaboration process, and being able to support long-term collaborations in a variety of ways. One model for such a collaboration environment uses a collaboration space as the basic unit. Some feature sets of a collaboration space environment include views, spaces as communication endpoints, space persistence and structuring, a variety of types of embedded objects, space history, embedded gadgets and robots, semantic processing, and integration with other collaboration frameworks. This approach can categorize, illustrate, and analyze new types of feature interactions for collaboration platforms with comparable feature sets.

Enterprise collaboration platforms include web conferencing systems, online document editing, shared document repositories, and voice and video conferencing, for example. The convergence of Internet-scale telephony, messaging, rich internet applications (RIAs), web, online media, social networking, and real-time information feeds has rapidly enlarged the design choices and made it possible to launch mass market collaboration applications, distinguished not by major feature differences but by stylistic associations such as tweeting, yammering, Skyping, instant messaging, and blogging.

This disclosure adapts these tools and platforms to increase their utility for information workers in enterprises. Further, this disclosure provides for seamless integration of intelligent communication capabilities such as highly composable collaboration spaces including space addressing and nesting, collaboration spaces as communication endpoints, space history and temporal control which includes semantic time markers and layered time relationships, and group management and information security. The principles disclosed herein are independent of any particular underlying collaboration tool and focus on the general features of collaboration systems.

Disclosed are systems, methods, and non-transitory computer-readable storage media for communicating via a collaboration space. For the sake of clarity, the method is discussed in terms of an exemplary system configured to practice the method. The system assigns a communication endpoint identifier to a collaboration space having at least one entity, receives an incoming communication addressed to the communication endpoint identifier, and transfers the incoming communication to at least one entity in the collaboration space.

The collaboration space provides a shared persistent container in which entities can perform collaboration activities. In one aspect, the entities in the collaboration space each have a unique identity. Some entities can be non-human, system-owned entities known as robots. Entity can have an individual view of the collaboration space based on an entity-specific dynamic context. Entities can share these individual views with other entities. The endpoint identifier can be a unique communication identifier, such as a telephone number, an email address, an IP address, a username, and so forth. The collaboration space can include shared resources such as documents, images, applications, and databases. The collaboration space can be an enterprise collaboration space, or a public collaboration space with unrestricted access.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary collaboration space;

FIG. 3 illustrates an exemplary user view of a collaboration space;

FIG. 4 illustrates a sample enterprise collaboration framework;

FIG. 5 illustrates an example sharing view across spaces;

FIG. 6 illustrates an example system integrating session context; and

FIG. 7 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

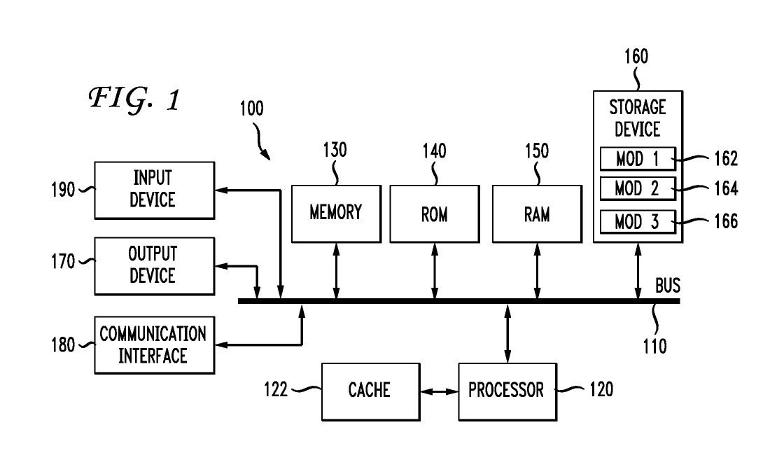

The present disclosure addresses the need in the art for integrating enterprise communications in collaboration spaces. The approaches disclosed herein address the need for better integration of intelligent communication capability with collaboration environments, the value of simplifying the creation and initialization of new collaborations, the importance of being able to structure collaborations and treat them as persistent and externally referenceable, since enterprise collaborations are often long-term, deal with complex information, and are important to document. A framework addressing these needs uses increased automation, meta (view) mechanisms, integration with external information and communication resources, and semantic processing where feasible. A brief definitions section is provided herein, followed by a brief introductory description of a basic general purpose system or computing device in FIG. 1 which can be employed to practice the concepts. Then the disclosure turns to a discussion of some features of an enterprise collaboration model and collaboration views. A more detailed description of the exemplary method will then follow. The disclosure describes multiple variations as the various embodiments are set forth.

The disclosure now turns to the definitions section. These definitions are illustrative; other suitable substitute definitions can be used.

A space, or collaboration space, provides a shared persistent container in which users perform collaboration activities. A space requires resources, such as computation, communication, and storage devices, to support those activities. For example, Google Wave, Microsoft SharePoint, and many virtual worlds, such as Second Life, are all examples of collaboration spaces. Collaboration offers a common workspace with user-specific personal views to a collaboration workspace. The view contains materials that assist individual users in the collaboration space. A multi-model collaboration space is a collaboration space shared across multiple models or capable of being shared across multiple models. For example, a single multi-model collaboration space can include participants using different interaction clients (or models) such as Google Wave, Second Life, Twitter, and so on. In one embodiment, a multi-model collaboration space incorporates or relies on a translation module that translates information, communication, and client capabilities for participants in the different models.

A view of a shared space is a user-, group-, or project-specific meta perspective of the collaboration space that itself can be shared, annotated, analyzed, and stored for further retrieval.

An entity is an agent that can view and modify the space and its attributes. Entities are also referred to as members of a space. Each entity has a unique identifier.

A contact is any entity with which a given user may share a space.

A user is a human entity.

A robot is a system-owned entity that can automatically perform some actions in the space.

An avatar is a representation of an entity in a space.

An object is a component embedded in a space that users and robots can interact with or manipulate. The system and/or users can create an object. Objects can include content, gadgets, real-time information sources, other spaces, and/or gateways to components of other collaboration platforms.

A gadget is an object that contains application logic that may affect other entities or communicate with applications outside of the collaboration space.

A collaboration application provides certain functions to manipulate entities in a collaboration space.

An event is used in an event driven collaboration space to notify one entity about the system and/or other entities' states and activities.

A session is a collection of collaboration activities among users, robots, and objects. A session spans a certain period of time, contains some specific semantic information, and requires resources, such as communication channels, storage, and network bandwidth, to support the collaboration activities. A collaboration space can include one or more sessions. Each session can include session-specific robots and/or objects. For example, a wavebot becomes active only if a user invites it to a session. A robot can be associated with a specific user. One example of such a robot is a personal assistant robot. The personal assistant robot can help a user manage his or her sessions by preparing documents, automatically creating a session and inviting him or her to join, recording the session, and so on.

A template is a pre-initialized set of objects that can be inserted into a space to provide a pattern for a particular collaboration activity or group of collaboration activities.

A policy is a rule specified by the entities managing a space and enforced by the multi-model collaboration framework that specifies constraints on sharing and accessing the space and its objects. The collaboration framework can be open.

Some collaboration tool features include creating a new collaboration space, adding collaboration tools and applications, initiating communication with members of the space or with individuals associated with the space, and managing access controls to the collaboration space.

Having discussed some exemplary definitions, the disclosure now turns to the exemplary system shown in FIG. 1. The exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

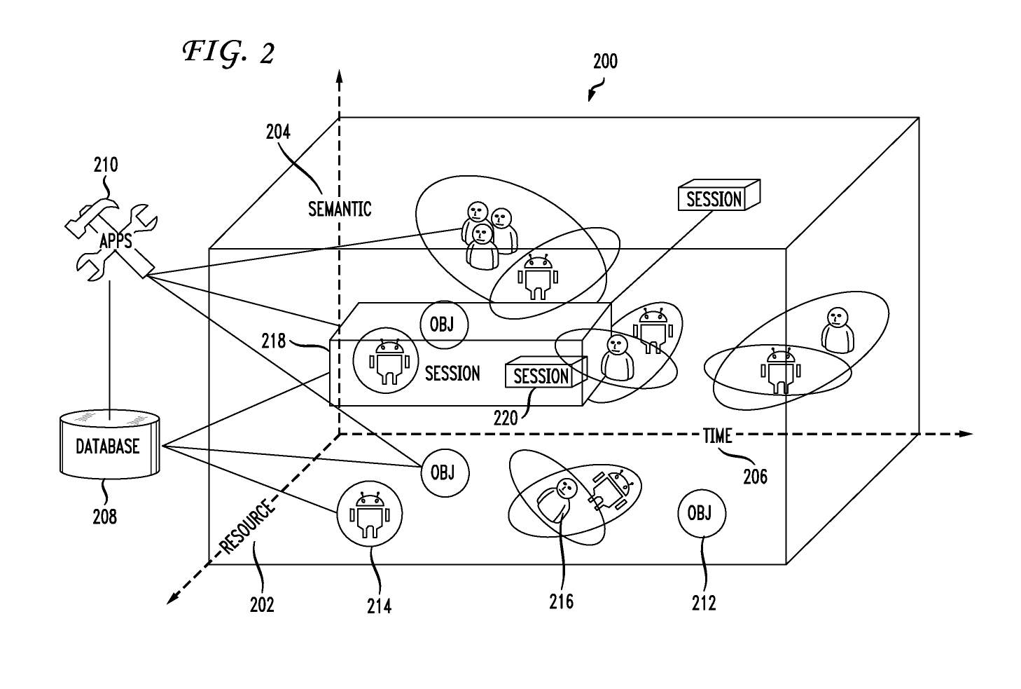

Having disclosed some basic system components, the disclosure now returns to a discussion of the exemplary enterprise collaboration model as shown in FIG. 2. As shown in FIG. 2, a collaboration space 200 can be represented in three dimensions: resources 202, semantics 204, and time 206. Each object 212 in the collaboration space 200 uses some resources, spans a certain period of time (the life cycle of the entity), and has certain semantic properties (either pre-defined or dynamically updated). Each space 200 has one or more entities 214, 216 which are members of the collaboration. Each entity has a unique identity. Entities can be organized in groups, and groups can be members of a collaboration space. A collaboration system can mange entity identities. System-owned entities 214 are “collaboration robots” or simply robots and other entities 216 can be humans. In the collaboration space 200, a member entity's space can operate on sharable objects 212, such as documents and images. Other resources available to member entities in the collaboration space 200 include applications 210 and databases 208.

Collaboration spaces can be nested. As shown in FIG. 2, one space 218 can include or refer to another space 220. In one aspect, robots 214 and objects 212 are session specific or owned by a particular session, meaning that the lifecycles of such robots and objects are limited to the scope of their associated session. Robots and objects can also be session independent or associated with a specific user. For example, a user has an assistant robot that helps her manage her sessions, by preparing documents, automatically creating a session and inviting her to join, and recording the session. A collaboration space can contain or nest another collaboration space. A collaboration space can link to another collaboration space. Each space or nested sub-space can be individually addressable. Collaboration spaces can be nested at multiple levels. A containing collaboration space and a nested collaboration space can be different modalities or environments. In one aspect, users can navigate collaboration spaces via a navigable hypergraph.

A session represents a collection of collaboration activities among users, robots, and objects within a space. A session spans a certain period of time, contains some specific semantic information, and requires resources, such as communication channels, storage, and network bandwidth, to support the collaboration activities.

Outside of the space, applications can manipulate objects in the space or provide collaboration channels. For example, call routing functions can be considered as collaboration applications. Embedded communications widgets are one example of such an application. In addition, the manipulation of user preferences and policies about appropriate collaboration behavior in space can also be considered as collaboration applications. The system can save these policies, preferences, and the history of the collaboration activity information in a database 208 for later reuse or for mining by analytical/reporting functions.

Collaboration sessions can provide functionality such as setting up shared sessions, adding collaboration tools, communicating within or outside the space, and managing access controls to the collaboration spaces. The term space indicates a collaboration environment with one or more members or a container for collaboration. In various implementations, spaces are known as TeamRooms, shared workspaces, media spaces, waves, or a shared virtual world space that allows participants to interact with each other.

Several collaboration features and functionality can be important for enterprise applications, such as functional grouping. The features in one category can be dependent or independent and can interact with features in other categories.

When setting up sharing in collaboration spaces in an enterprise, valuable meeting time can be lost or wasted to gather the appropriate content to the shared spaces. Collaborative spaces can persist, thereby allowing instant access to the previously shared content and a set of commonly used tools. A view of a shared space is a user, a group, or a project specific meta perspective of the collaboration space that itself can be shared, annotated, analyzed, and stored for further retrieval. In a collaboration space, the system can instantly bring user specific dynamic context to a collaboration space. The disclosure turns first to a discussion of user-specific views.

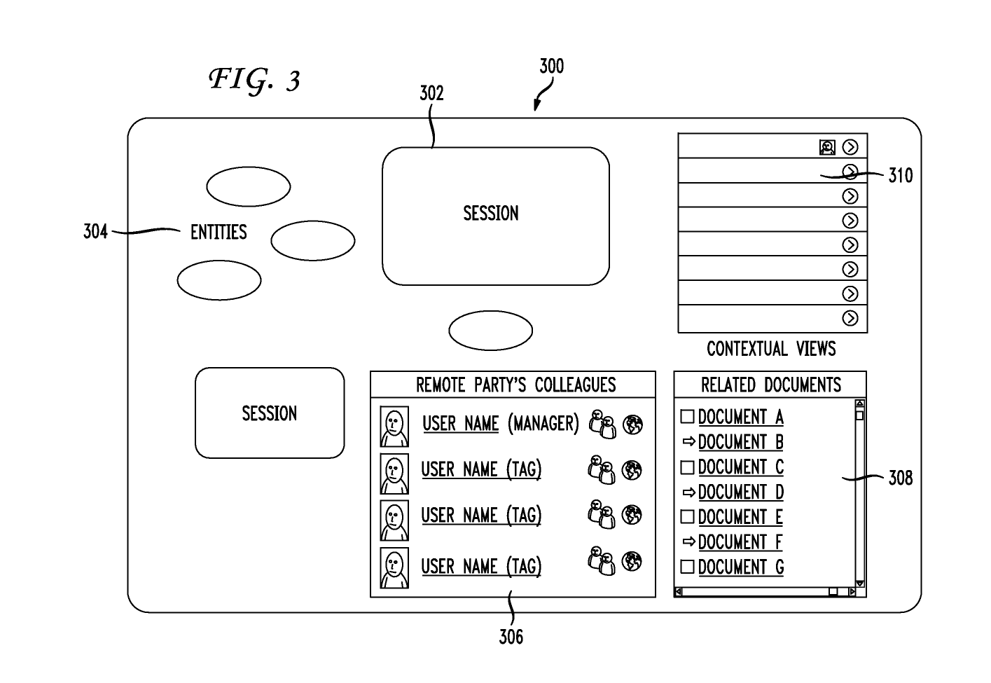

A user-specific view allows an overlay of views to collaboration sessions based on users' personal data and preferences. An example of such a feature is a gadget or an object in a shared space that presents user specific dynamic data such as their interactions across enterprise data that is not shared with all the participants in the session. This overlay can privately present appropriate information to a user in their active session. User-specific views can be context-sensitive based on a user profile, user device, user location, user permissions, and so forth. FIG. 3 presents one view 300 in a simple embodiment. This view 300 provides a context-sensitive user specific workspace in a shared collaborative space. Robots or other automated agents, can manage views on behalf of a user. FIG. 3 depicts a simple collaboration space of an end-user including sessions 302 and entities 304 as an overlay of a user's collaboration space with two views that contain data mined from user's data. The first view is a view of relevant contacts 310 that captures the user's collaboration context, mines data from user's previous sessions, email, calendar, and other data sources to present a list of contacts that the user may need during the collaboration session. The second view is a relevant documents view 308 that presents documents that may be useful for the user in the current session. FIG. 3 also shows a third personal view that relates to the context of a session. It shows a list of shared colleagues with the remote party 306 of a session. FIG. 3 shows a context-sensitive, user-specific workspace in a shared collaborative space. Robots can automatically manage the views. The system can dynamically generate views. Users can share views or subviews across several users, sessions, and/or collaboration spaces.

These simple examples of views present two important aspects. First, views enhance a user's interaction in a collaboration session. Second, these examples demonstrate views' dynamic and context-dependent nature. In contrast, the contacts gadget in Google Wave, for example, is a personalized view but is static and does not depend on the collaboration context.

With appropriate access control mechanisms and authentication, users can share personal views with other users or with users who are not participating in the collaboration sessions. In one implementation, this feature is a sidebar between a group of users in a collaboration session. In enterprise collaboration, where access to information and resources is often hierarchical, a manager may wish to share views with a delegate to make appropriate decisions during a collaboration session, or share views with other management-level participants but not with others. Views can be attached to a specific collaboration space. For dynamic views, robots can ensure that the views are synchronized appropriately with the content of the corresponding collaboration space.

The disclosure now turns to a discussion of sharing spaces and navigation within those spaces. Typically, collaboration tools provide capabilities such as a desktop application sharing, document sharing, audio/video conferencing, and the ability to add new tools to shared collaboration spaces. Despite being part of a shared space, these tools are independent, meaning that the navigation controls and context of these tools are not visible to the other tools or gadgets in the collaboration space. Users work with each of these tools appropriately to connect with the context of their collaboration. Some static context such as participants and existing documents can be shared in some collaboration space gadgets, but this notion is not extended to inter-gadget communication or navigation. Collaboration spaces can offer extensions to provide new features that include dynamic exchange of context and navigation in across gadgets in a collaboration space.

Users and objects can share spaces inter-session. Collaboration spaces can allow objects that communicate with each other during a collaboration session. As an example, consider a collaboration session with a tool (gadget) that handles shared relevant documents. If a new user joins the collaboration space through a communication session, the shared relevant documents gadget automatically updates its content to include documents that relate to the new participant. As discussed above, collaboration spaces can include nested spaces. These nested spaces allow users to focus on a particular issue or permit a sub-session that contains confidential data. The participants in a nested space can be a subset of those participants for the parent space. The nested space has a unique identifier that can be externally referenced, for example, by another space.

Within the collaboration sessions, users can navigate within a gadget or an object to automatically be reflected in other objects. Users can employ a semantic temporal navigation approach to space history by structure and semantics. For example, users can navigate a space timeline history by participant action, by topic, or by a combination of other navigation criteria.

A user can manage various features of collaboration sessions. Apart from the basic management of starting, ending collaboration spaces and making a collaboration space persistent, collaboration spaces can provide additional features to assist user interactions with collaborations sessions.

Based on the information available in stored or existing spaces, robots can automatically create new spaces or initiate communication sessions in existing spaces. The system can suggest collaboration spaces or sessions based on topic(s), for example, which relate to content in existing collaboration spaces or based on participant availability. The robot predicts the participants, the gadgets or objects required, and the data required to assemble an initial collaboration session.

Collaboration has a structure, and the purpose of the collaboration shapes the structure of the discussion. For example, parties can collaborate for negotiation, project planning, hiring, investment, and so forth. A template is a predefined set of objects, tools, and/or participants designed to support a particular collaboration purpose. When a collaboration is initiated, the creator, another user, or the system can select a template upon which to based the new collaboration, thereby saving users time in preparing the space for the intended collaboration. Further, users can save a session and/or space template for future use. For example, a user save a current collaboration session as a ‘department collaboration session’. The stored template understands the participants, their capabilities, their context, and starts up a collaboration session with the appropriate collaboration space, gadgets, views, and content.

Collaboration spaces can be represented as communication endpoints. A communication endpoint can include a unique address, such as a telephone number, extension, IP address, Uniform Resource Locator (URL), or email address. This communication endpoint approach provides a number of benefits. For example, each communications within a space is part of that space's content and history. Communications capability to all space members is, by default, integrated in each space without additional effort by the user. Different spaces can be used to organize one's past and future communications. Communications to non-members can be provided by embedding specific communications gadgets with those participants. This means that the space is addressable for communications signaling and that all members of the space can be notified for call initiation. Potentially, non-members can also call the space. One way to obtain addressability is to associate a unique identifier in a telephony network with each space instance. For this purpose, the framework can include or integrate a Session Initiation Protocol (SIP) stack or other call stack, and automatically register each space with the appropriate registrar. The collaboration space can be assigned multiple communication endpoints of different modalities, such as a mobile telephone number and an instant messaging login.

In one aspect, collaboration spaces represented as a communication endpoint are addressable for all forms of communications signaling. Further, the system can automatically enable communication as part of the collaboration session. The system can capture each communication session into a space history. The system can map the collaboration space to communication capabilities, resources, and views needed by the participants. Non-members of the collaboration space can join the collaboration space using the communication endpoint address.

Each space can include a default communications device representation, such as a softphone interface in a 2D space or a 3D representation in a virtual world. This representation is then bound to one or more personal communication devices. A member uses their local device representation as the interface. A user can initiate the call as conference call to all the members of the space, a subset, or other endpoints. Robots which are members of the space can be on calls or initiate calls through the space, provided the media type of the call is supported by the given robot. The disclosure turns to several examples illustrating these concepts.

In a first example, Alice 502 defines two spaces, one for work and one for recreation. Bob 504 is a member of each space. Alice 502 selects the communications device for the space to initiate a call to Bob 504. Bob 504 gets a call initiation indication on his device representation(s) for the given space. In a second example, Alice 502, Bob 504, and Charlie are members of a space. When one of them initiates a call, the other two members receive a call initiation indication on their device representation(s). This is a type of follow-me conferencing. If Jim (a non-member) initiates a call to the addressed assigned to the space, then the associated endpoints of Alice 502, Bob 504, and Charlie each receive a call initiation indication. In a third example, Alice 502 uses the communications device in the recreation space to call Bob 504. The call events are included in the recreation space timeline. Later Alice 502 calls Bob 504 using the communication device in the work space. The call events are included in the work space timeline.

The disclosure now turns to a discussion of context aware collaboration sessions. Enterprise collaborations have two factors that distinguish them from other forms of collaboration. One is the context that surrounds the collaboration session and the other is the need for a sequence of related collaboration sessions over a period of time. Although the participants are important, the context and temporal aspects can be equally important. For example, collaborations that involve a project continue even if the team composition changes, such as when new employees are added to the team, promoted, or leave. Context is a general term that capture key aspects of collaboration sessions such as the intent of the collaboration, temporal nature of data, content associated with the session, information about participants, and other metadata.

One feature of such context aware collaborations is to allow applications, such as relevant contacts, to use the context to mine relevant data to generate a user specific view for the session. The intent of one participant, a customer, can be the context of a collaboration session. This collaboration can involve an appropriate customer agent with one or more experts working together to resolve the customer issue.

Collaboration sessions can include groups of users. The capabilities and access controls can be managed as a group. The group can have a separate group view that contains data mined from the group's information and shared among members of the group. The ability to have groups allows collaborations to include a large set of people without requiring all of them to be part of the collaboration space and without managing their individual identities.

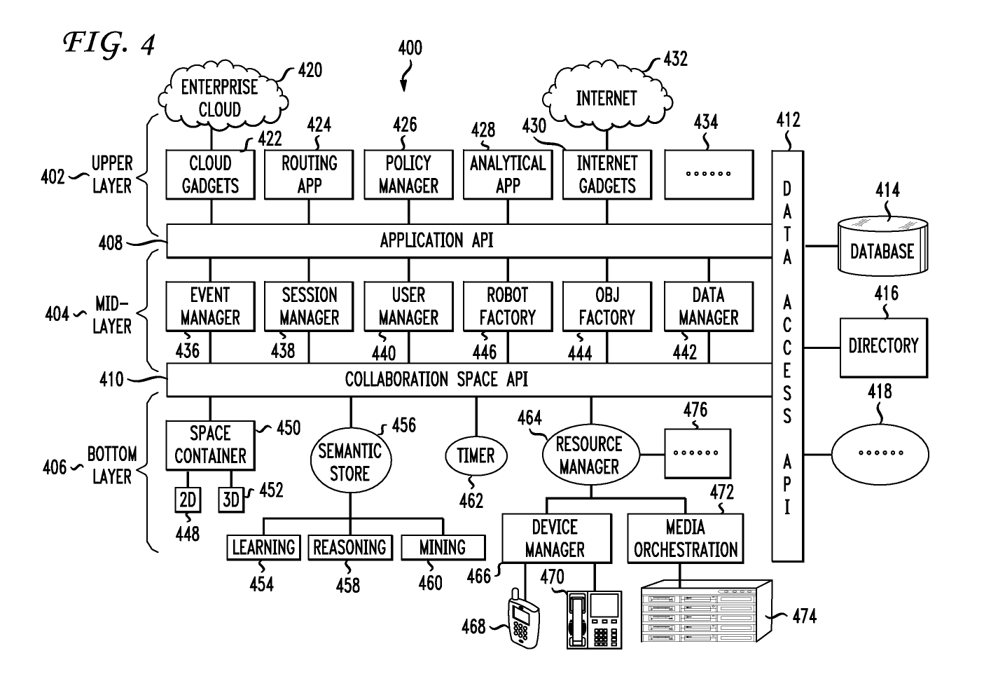

FIG. 4 shows an exemplary collaboration sessions framework 400. The framework is an architectural organization of the collaboration semantics that can be implemented in software, hardware, or a combination thereof. The framework allows unified user access to different types of collaboration spaces mediated by different servers. Based on the collaboration space model in FIG. 2, the framework consists of three layers: a bottom layer 406, a middle layer 404 and an upper layer 402. The bottom layer 406 manages the three dimensions of the collaboration space. The middle layer 404 manages the entities in the collaboration space. The upper layer 402 is a collection of collaboration applications. All three layers can access data entries 414, 416, 418 through the data access API 412.

In the bottom layer 406, the semantic store 456 manages information mined from persistent and/or stored collaboration data, such as keywords extracted from users' emails and conversation tags. The semantic store 456 handles tasks such as learning 454, reasoning 458, and mining 460. The timer 462 manages timestamps and can generate timeout events. The resource manager 464 controls, via a device manager 466, multiple end-user communication devices 468, 470, orchestrates 472 one or more media servers 474, and otherwise manages additional resources 476. The space container manager 450 contains helper functions that can manage multiple 2D 448 or 3D 452 collaboration spaces. For example, the framework can embed collaboration spaces of Google Wave and Avaya web.alive together. In this case, the system can translate different collaboration space models to a sharable view.

The bottom layer 406 and the middle layer 404 communicate via a collaborative space API 410. In the middle layer 404, the robot factory 446 handles system-created robots, and the object factory 444 manages the objects in the collaboration space. The user manager 440 handles user registration and manages user profiles. The session manager 438 can create, update, and delete sessions and maintains session information. The event manager 436 and data manager 442 contain helper functions that manage events and session data in the middle layer 404.

The middle layer 404 and the upper layer 402 communicate via an application API 408. The upper layer 402 contains different applications that can manipulate sessions, users, robots, and objects. Some example applications include cloud gadgets 422, a routing application 424, a policy manager 426, an analytical application 428, internet gadgets 430, and others 434. The applications can subscribe to the event manager 436 to get event notification. The applications can also interact with other applications locally or remotely, such as in an enterprise cloud 420 or over the Internet 432. The applications have access, via the data access API 412, to the database 414, a directory 416, and other resources 418.

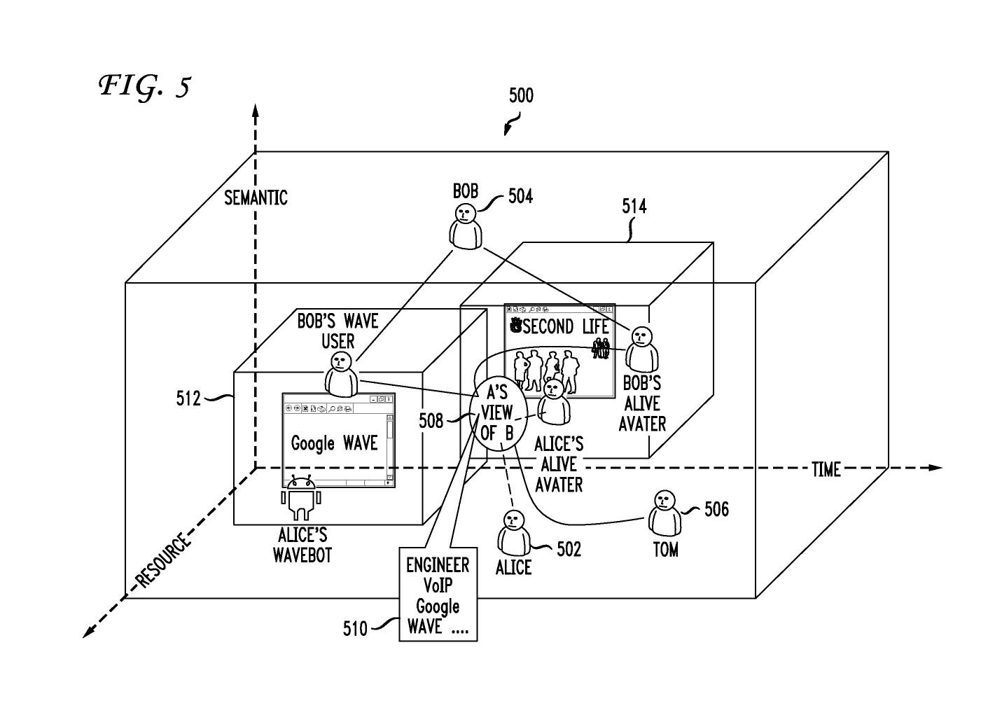

FIG. 5 shows an example of nesting two sub-spaces 512, 514 in a collaboration session space 500 and sharing views across spaces. In FIG. 5, Alice's 502 view 508 of Bob 504 is a personalized version of Bob's 504 social profile that is specific to Alice 502. The view 508 of Bob 504 can include information or metadata describing Bob 504, the view 508, the relationship between Alive 502 and Bob 504, and other data. This personalized social profile can be generated by mining into Alice's 502 wave conversations. Alice's 502 avatar in the collaboration session space 500 can then access and bring this view 508 to the collaboration space in Second Life 514, a virtual world environment. When Alice 502 meets Bob 504 in Second Life, this view 508 can be shown along side of Bob 504. Alice 502 can also share this view 508 with the third user, Tom 506, for a specific duration of time in the collaboration session space 500. During the sharing period, when Tom 506 meets Bob 504 in Second Life space 514, Tom 506 may also see the view 508. To achieve this feature, the data manager 442 in the middle layer 404 collects data, the analytical application 428 in the upper layer 402 mines the data and generates the view, and the semantic store 456 in the bottom layer 406 stores the view. The space container 450 in the bottom layer 406 can manage the relationship of the collaboration session space 500, Google Wave space 512, and the collaboration space 514 in Second Life. The policy manager 426 in the upper layer 402 and the user manager 440 in the middle layer 404 can handle access control. When two users meet in Second Life, the event manager 436 gets the event and the session manager 438 creates a session with two users. During the session, the object factory 444 creates a view object from the collaboration session space and presents it in Second Life.

The semantic meaning of entities can enable many new collaboration features. For example, in FIG. 5, Alice 502 groups people in her contact list based on the views of those contacts. She can then perform certain activities based on those semantic groups, such as “send Google Wave invitation to all the engineers in my contact list”. Note that the “view mining” and “view sharing” features in FIG. 5 enables this “semantic grouping” feature. If the mined semantic information is inaccurate, the “semantic grouping” features can misbehave. This is in fact semantic based enabling feature interaction.

The disclosure now turns to a discussion of feature interactions. Open platforms with distributed shared resources represent systems with specific affinity for feature interactions that cannot easily be engineered away due to the number of contributing developers and continual change in the services. A formally defined run-time feature interaction and detection approach can resolve this issue. The system detects at run-time the potential for features to interact and either blocks the low priority feature causing the interaction or alerts the affected user to take action.

In addition, new categories of feature action in collaboration environments can be used besides and/or in addition to telephony and the web. The system can categorize feature interactions according to the functional areas described above. Various examples of feature categories and feature interaction categories are provided herein. The first feature category is space composition. The space composition feature category includes multiple feature interaction categories. One feature interaction category represents multiple simultaneous writes to a non-transactional shared resource in one or more spaces via gadgets. An example of this category is a calendar gadget to a group calendar in different spaces for Alice 502 and Bob 504, which updates the same entry in the group calendar at the same time.

In another feature interaction category, one or more read operations are simultaneous with a write of a non-transactional shared resource in one or more spaces via gadgets. In an example of this category, Alice 502 and Bob 504 use a meeting room reservation gadget to book a specific meeting room via the company's meeting room reservation site at a specific time. Alice 502 accesses the reservation form first and finds the room is available, and but it needs a projector. Alice 502 takes time to decide. Bob 504 signs on and reserves it instantly. Alice 502 decides to reserve the room, and finds it is no longer available.

Yet another feature interaction category under the space composition feature category is changing application data through a gadget while simultaneously using the application to update the data outside the space. In this example, Alice 502 directly updates a group calendar at a specific entry while Bob 504 updates the entry using a gadget in a shared space. Another feature interaction category is two or more “real-time” features, mediated by gadgets in the same space. Alice 502 and Bob 504 are simultaneously using a shared space which contains one gadget which is viewing an eBay auction and another gadget to place bids for the same auction. Bob 504 is placing a bid while Alice 502 is viewing the auction. Alice 502 sees the bid transmitted but doesn't see the auction view updated. Alice 502 embeds a real-time search gadget into her space which looks for postings in the blogosphere about her company's products. Around the time of new product announcements by her company, the search gadget produces a burst of redundant results from different sites distributing the same press releases. Alice 502 embeds a follower-gadget into her team's space which follows blogs by other company product groups. Later Alice 502 is transferred to one of the other product groups and publishes a blog for it. Her blog entries end up in her original team's space.

Yet another feature interaction category under the space composition feature category is space persistence and user memory. In this example, Alice 502 creates a space Si with a robot entity. The robot creates a new sub-space and sets up a real-time feed of related topics whenever Alice 502 updates her interest profile. Later, for another space S2, Alice 502 adds a general topic to her interest profile, resulting in the creation of many sub-spaces in S1 and insertion of auto-subscriptions.

The last feature interaction category for space composition is dynamic membership. Alice 502 is a member of space for a certain time and then leaves it due to change in job function. When Alice 502 later replays the space history, the space replay function allows her to see space sessions after she left the space membership.

The disclosure now turns to the second feature category, space as a communications endpoint. The first interaction category for a space as a communications endpoint is that a space has incoming and outgoing “call” capability and adding conventional call feature sets introduces conventional feature interactions. For example, a space can include call forwarding with call blocking

A second feature interaction category is robots making simultaneous incoming calls. A robot can call two spaces of Alice 502 at the same time. Multiple robots can call into the same space of Bob 504 at same time. Multiple robots can call into different spaces of Alice 502 at the same time.

A third feature interaction category is incompatibility between call origination and call termination features. For example, Alice 502 and Bob 504 share a space but have different call origination and call termination feature preferences. Alice 502 and Bob 504 have different block lists, and Alice 502 can enable call waiting while Bob 504 does not.

A fourth feature interaction category is calls between members of spaces as opposed to calls to/from non-members. In this feature interaction category, Alice 502 and Bob 504 share a space S1. Alice 502 gives Charlie the space address to discuss something related to the space. Charlie calls Alice 502 and the conversation about the topic is captured in to S1. During the conversation, Charlie brings up personal information that Alice 502 doesn't want Bob 504 to know. Alice 502 can control how that information is included in the space, if at all, such as permissions, visibility, duration (how long will the system hold the information before deletion), and so forth.

A fifth feature interaction category is device limits. In one example, Bob 504 is outside the office and has set the system to forward communications for certain spaces to his cell phone. Bob 504 can participate in communications within those spaces but due to limits of his cell phone, Bob 504 cannot see the information displayed that others members of the space see.

A sixth feature interaction category is private communications. Alice 502, Bob 504, Charlie and Dawn share a space. Charlie and Dawn insert a private sub-space to discuss a topic related to the space. A robot that generates meeting highlights and that was added by Charlie in the space is able to see the private sub-space and posts highlights of the sub-space to the space.

The third feature category is embedded communications. One feature interaction category is conventional telephony features interactions. A second feature interaction category is intra-telephony gadget coordination. For example, Alice 502 and Bob 504 share two spaces, S1 and S2. Alice 502 embeds a SIP-based telephony gadget in S1 and Bob 504 embeds a Skype-based telephony gadget in S2. When Alice 502 is on either gadget, and takes an incoming call on the other gadget, the system does not automatically place the first call on hold. A third feature interaction category is sharing conflicts. Alice 502 and Bob 504 share two spaces, S1 and S2. Each space has an embedded telephony gadget. Alice 502 answers an incoming call to gadget in S1. While the first call is active, an incoming call to the gadget in S2 arrives. Alice 502 has configured go-to-cover on busy. Bob 504 answers the second call while the connection to Alice 502 goes to cover.

The fourth feature category is component-to-component communication. A first feature interaction category is robot feedback loops. Alice's 502 space produces an RSS feed using a robot, such that when the space is updated by an entity, a summary entry may be placed in the feed. Alice's 502 space receives other RSS feeds from other spaces. Bob's 504 space receive this Alice's 502 feed into his space, which also produce RSS feeds via a robot. Charlie's space receives Bob's 504 RSS feed and publishes to a feed received by Alice 502 in her space, creating a feedback loop, such that one or more entries published by Alice's 502 feed are passed back to her space via Bob 504 and Charlie's connection, leading to continual republishing. A second feature interaction category is robot ping-pong. Robots S3E3 and D4QP are members of Alice's 502 space and insert new content from external sources when an entry in the space triggers the robot. Later the operators of D4QP expand its triggering and topic publishing list so that S3E3 and D4QP overlap and trigger each other to add entries to Alice's 502 space continuously.

The fifth feature category is group management. One exemplary feature interaction category identifies equivalence not enforced across group manager boundaries. In one example of this category, Alice 502 has Tom 506 on her block list. Tom 506 is a member of group G1. Alice 502 creates a space with group G1 as a member. Tom 506 is able to access the shared space by virtue of his membership in group G1 despite being on Alice's 502 block list.

The sixth feature category is semantic synchronization. The semantic channel can be out of sync with the syntactic channel. For example, Alice 502 and Bob 504 have a shared space and add a robot that provides real-time expert advice on topics discussed in the space. In addition, a separate robot provides transcription service. During a conversation in the space, Bob 504 refracts an earlier point. This is recorded by the transcription service but the expert robot misses the refraction in the semantic level and continues to refer to the original point.

The disclosure now turns to a discussion of space composition and organization. Spaces can be hierarchically composed so that entities can structure the space to enhance navigation of its content. The variety and types of objects that can be included in a space is open and can be extended beyond the collaboration platform to include websites, real-time information sources, applications, and other collaboration and communication environments.

A type of feature interactions that can arise as a result of this composition model is due to simultaneous manipulation of shared information on remote applications, through gadgets embedded in spaces. Users may or may not know of the sharing, depending on how the system mediates access to the remote information source. Since the shared information is stored outside of the space, the numbers of simultaneous spaces and users that may reference the spaces are virtually limitless. In addition, gadgets from different application providers can reference and use the same information or application data, and may not be designed to coordinate.

Further, the user can access the same applications and information through tools outside of the collaboration framework. For example, a user can update his desktop calendar directly as well as through a gadget in a space. This example is a distributed synchronization problem of state inconsistencies for applications without transactional mechanisms. The framework can provide a protocol for locking or consistent distributed time-stamping to resolve these synchronization issues, but there is nevertheless the possibility that some external information systems may not provide or utilize this support. For example, a web.alive gadget is embedded in a space that shares a user's desktop. Members of the space can simultaneously change the desktop including attributes of a collaboration sessions application.

The space itself can represent a communications endpoint, meaning that the space is addressable for communications signaling, and that all members of the space are notified for call setup. Several categories of feature interactions can occur when a space is a communications endpoint due to use of conventional telephony features like call forwarding and call blocking, due to sharing of a communication endpoint, effecting issues such as which user's features are used, calls between members of spaces as opposed to calls to/from non-members, due to concurrency between communication activities in different spaces for a given user, due to asymmetry from views, local configuration, different underlying telephony services for each user, user and/or locale-specific filtering, due to private communications where privacy boundaries may not be stringently recognized by robots, the history mechanism, or views, and due to other causes.

Embedded communications refers to real-time communications applications such as softphones embedded as a gadget in the space. This enables communications to include the space as context, and the communications act to become part of the space record. In one example, a space includes two call gadgets. One has an active call. When a call comes in on second gadget, the space can place the original call on hold automatically. In one variation of this concept, the two call gadgets can be in separate spaces. In another variation, the gadgets are for different services, such as peer-to-peer (P2P) and SIP, especially when they are in different spaces.

Objects can communicate directly, via connections within a space, or indirectly, through external connections. This is known as component-to-component communication. Component-to-component communication can lead to feedback loops and ping-pong interactions between robots. In addition, third parties can provide robots and gadgets. During the lifetime of a space, a provide can change the configuration of a robot or gadget. Thus an interaction can be uncovered between robots due to a subsequent configuration change.

In collaboration systems without user roles, a fundamental aspect of a shared space is symmetry among the participants. This assumption of symmetry underlies user behavior. Some features can introduce to asymmetric perspectives in a shared space, due to local settings (filters, block lists), or the asymmetric nature of the application (calls). For example, a stock ticker gadget gets live updates. Everyone belonging to the space sees (approximately) the same view as new updates arrive. In another example of local filtering, Alice 502 has settings that block certain types of news stories on news feed embedded in the space. Bob 504 has no such setting. Bob 504 can see certain news stories in the space, Alice 502 can not. In another example of locale-based filtering, Alice 502 is in country A, and Bob 504 is in country B. Alice 502 embeds a restricted web site gadget in the space. Bob 504 can not see it. The locale can be a particular location or it can be a combination of location and time. For example, the locale can be a home office between 9:00 am and 5:00 pm. Outside of those hours, the same physical location is not part of the locale.

Group management includes activities such as group creation, establishing rules for group membership, and join/leave functions. More advanced features include filters based on group settings, and group nesting (i.e. groups of groups). Because many collaboration forums use different frameworks, it is convenient to be able to reference groups defined in external systems within the collaboration session group. For example, a mail list group set up in a standards body like Internet Engineering Task Force (IETF), or members of the contact list on a particular social network account can be used as a member of a space. For example, a group is a member of a wave. The membership of the group is determined outside the framework, such as at the IETF Working Group. The size of the group varies dynamically outside of the control of the wave.

Some attributes of the space depend on group size, such as the size of the voting gadget. In the case of a virtual world, a member is invited to a room in the space, but may be restricted from entrance due to a space constraint. The group membership update rate can be much greater than the capability of the server to handle additional members. This can lead to anomalies in enabling access. In one embodiment, the external group can circumvent or override block lists for a space.

Introducing real-time semantic operators and agents in the space also introduces interesting feature interaction categories. One feature interaction category is synchronization between semantic and syntactic channels. The following example assumes there is a voice call in the space and that transcription and summarization tools provide additional channels. Agent applications can monitor these channels to provide additional information to the participants.

channel 1: voice

channel 2: transcription of channel 1

channel 3: semantic summary of channel 2. Robots listen to this channel for keywords which trigger particular actions

A participant retracts something said previously. The semantic summary may miss the retraction or the robots listening to channel 3 may not recognize the retraction keyword. As a result, the robots continue to refer to the original statement.

Spaces can embed arbitrary applications and communications, have history, and can be used by automatic and real-time processes such as robots. This can lead to rich collaboration models that introduce many types of feature interactions. A run-time feature interaction mechanism can allow a large number of potential feature interactions and the pair-wise testing of all possible combinations of features can be expensive for a system in which many different developer communities continuously contribute new applications. Hence, a machine representation of features can automate the feature interaction detection. In one aspect, the Event-Condition-Action (ECA) model is sufficient and general enough to describe features in collaboration sessions. The ECA model is described by the pseudocode below:

feature::=(trigger, pre-cond, action, post-cond)
where:
   pre-cond::=(states, action parameters)
   action::=f(trigger, action parameters)
   post-cond::=(new triggers, new states, affected values)

Collaboration features include concurrent manipulation and viewing of a shared space S and its objects by two or more entities. Objects in the collaboration space can include communication widgets, embedded applications with state A which exists independent of the space, connections R which read the application into the space, connections W which write data from the space to the application, real-time information sources including real-time search, web pages with live updates, and publish/subscribe (using connections R) functionality, content objects such as images, audio, video, and other static information sources, and other shared spaces either in the same framework or in a separate framework. The shared space can be either two-dimensional or three-dimensional. The system captures the state of a shared space including all of its objects and sub-spaces at one or more discrete points in time. For simplicity, all objects and sub-spaces have common timeline and sample points.

The approaches disclosed herein apply to feature interaction problems involving spaces as communication endpoint as well as embedded communications. The approaches herein also apply to new types of interactions, not involving conventional telephony applications. For example, a space shares a user's desktop which members can manipulate. Through the manipulations conflicts may occur. A space can be expressed by a collection of states:

Sw(t), Sh(t)—dimensions of space at time t

S_{O}(t)—set of objects in S at time t

S_{E}(t)—set of entities, human or robot

S_{W}(t)—set of objects/entities that are writing to S in time t

S_{R}(t)—set of objects/entities that are writing to S in time t

Objects can be defined as a tuple consisting of an object ID, a unique address of the object instance, a type of the object, a set of connections which read and a set of connections which write to the object, and a set of current writer entities:

O(id, address, type, read-conn, write-conn, writers)

A space can be defined with 2 instances of the same object which are writable at the same time by different entities:

S_{E}(t)=e1, e2

S_{O}(t)=o1, o2

o1==o2

o1==O(ID, o1-address, any, _, _, {e1, e2})

o2==O(ID, o2-address, any, _, _, {e1, e2})

Then the system performs the following object operation stream:

e1:o1<=a

e1, e2: notify(o1)=a

e2:o2<=b

e2, e1: notify(o2)=b

This demonstrates a race condition between the two notifications arriving. One solution is to time stamp notifications using synchronized clocks. This scenario also assumes a number of shareable objects having resource sharing mechanisms that are not implemented or defined in a certain way. After the feature interaction analysis, the system can notify users when two or more of the same object are writable in the same space.

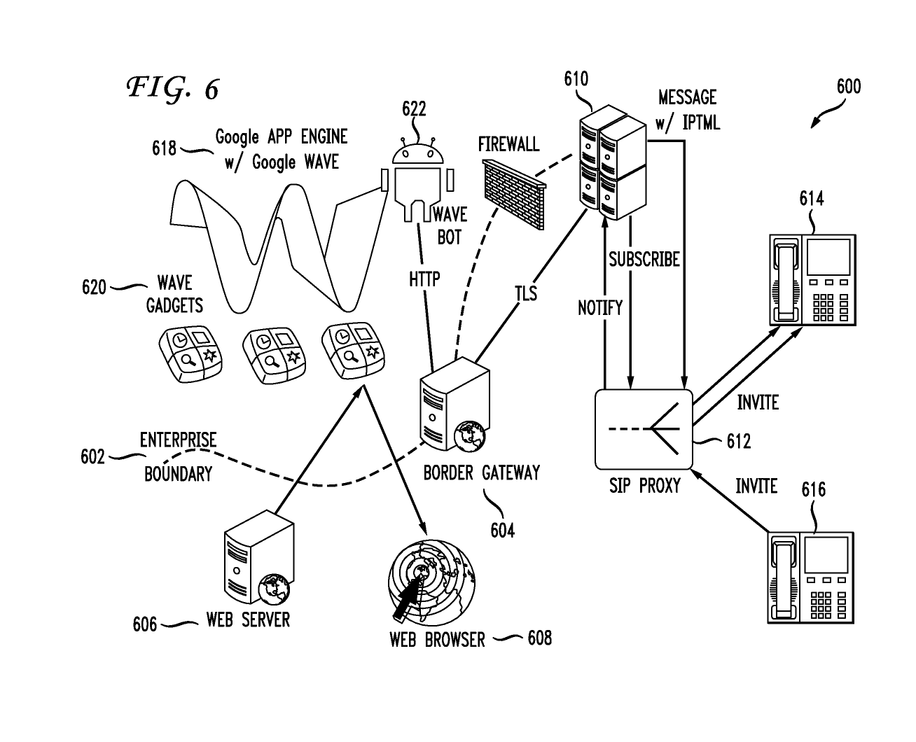

Returning to the bottom layer 406 of FIG. 4, the system builds a semantic store 456 by mining users' emails, call histories, and other documents to generate different views of users' collaboration space information. The system can import views from the collaboration space into Google Wave, Second Life, and other collaboration environments, as shown in FIG. 6. FIG. 6 shows the architecture 600 of this exemplary integration across an enterprise boundary 602. The enterprise boundary can be a physically separate network or can be connected to external networks, such as the Internet, via a firewall. On the enterprise side, the enterprise runs a web server 606, enterprise users operate web browsers 608, etc. A border gateway 604 bridges the enterprise side and the non-enterprise side. The border gateway translates between different models and manages system-specific protocols. For example, the border gateway 604 can translate a two-dimensional space to a three-dimensional virtual world environment. The border gateway 604 provides a way for collaboration systems from different vendors to integrate seamlessly into a common collaboration framework by mapping objects, identifiers, context, history, and other information between two or more different collaboration systems. The border gateway 604 communicates via transport layer security with other enterprise communication servers 610. The enterprise communication servers 610 communicate with communication devices 614, 616 via a SIP proxy 612. Various web-based or other public communication services operate on the non-enterprise side of the enterprise boundary 602.

For example, Google Wave 618 can be extended to bring session context information, such as related documents and recent shared contacts, from the collaboration space into Google Wave. In addition, Google Wave users can control their enterprise voice communication session. As part of the integration process, a border gateway 604 provides data access for allowing enterprise information to cross the enterprise boundary 602 and enter Google Wave space 618. A Google wavebot 622 retrieves the information via the border gateway 604 and presents the information to a wave gadget 620. For example, two avatars can interact in Second Life or some other virtual environment in a collaboration space, such as a customer care center. This customer care center contains various interactive 3D objects, communication objects, and access control mechanisms tied back to enterprise servers. Some components of this architecture and a use case scenario are discussed herein.

First, the avatars have personal views. Avatars can come in and check the status of their requests. Also, agents can come in and check the status of their pending jobs. Second, the avatars can share views. Some users can come in and check the status of pending requests and can offer help if they can (like a passer-by helping in a real-world scenario). Third, avatars can manage spaces. The enterprise can manager objects in the collaboration space via a resource manager as depicted in FIG. 3. Managing resources includes access controls, allocating, and clearing up resources. Fourth, sessions can be context aware. The system can capture the context of communications and send the captured context back to enterprise. Based on the context, in this case a service request by a customer, the enterprise service can bring in appropriate agent, resources, and/or initiated communication sessions.

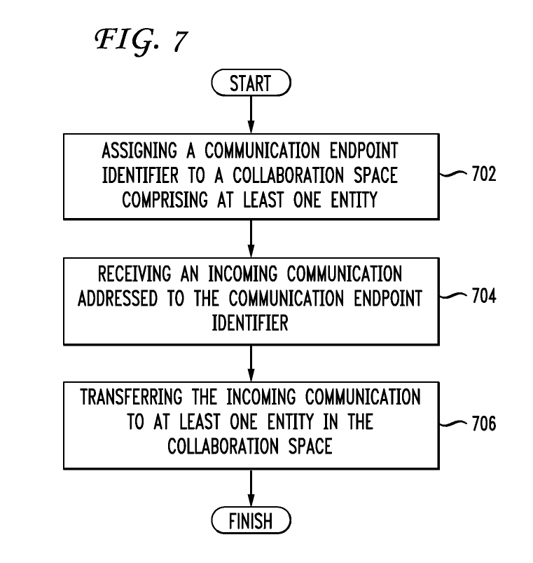

Having disclosed some example system components, architectures, and concepts, the disclosure now turns to the exemplary method embodiment 700 shown in FIG. 7 for communicating via a collaboration space. For the sake of clarity, the method 700 is discussed in terms of an exemplary system 100 as shown in FIG. 1 configured to practice the method.

The system 100 first assigns a communication endpoint identifier to a collaboration space having at least one entity (702). The collaboration space provides a shared persistent container in which entities can perform collaboration activities. In one aspect, the entities in the collaboration space each have a unique identity. Some entities can be non-human, system-owned entities known as robots. Entity can have an individual view of the collaboration space based on an entity-specific dynamic context. Entities can share these individual views with other entities. The endpoint identifier can be a unique communication identifier, such as a telephone number, an email address, an IP address, a username, and so forth.

As described above, the collaboration space can include shared resources such as documents, images, applications, and databases. The collaboration space can be an enterprise collaboration space, or a public collaboration space with unrestricted access.

The system 100 receives an incoming communication addressed to the communication endpoint identifier (704). For example, if the collaboration space is assigned a communication endpoint identifier of a phone number, the incoming communication can be a phone call to that phone number. Similarly, if the collaboration space is assigned a communication endpoint identifier of an instant messaging username, the incoming communication can be an IM request directed to that username. The system 100 transfers the incoming communication to at least one entity in the collaboration space (706).

In one embodiment, the collaboration space includes a recording component that stores a history of collaboration activity within the collaboration space. Users can then replay portions of the history or search the history of collaboration activity. Further, an analytics component can analyze and compare histories to identify usage trends. A user can save a particular history as a template for future sessions in the collaboration space. For example, a user can save a template of participants and resources used in one conference call for use with later conference calls.

A template is a pre-initialized set of objects that can be inserted into a space that provides a pattern for a collaboration activity. For example, a template can include a sequence of actions of one or more user or robots in a space as a temporal collaboration pattern. The template can include a list of participants, as well as participant capabilities, roles, and context. The template can also include the captured collaboration space, gadgets, views, and content. Users can edit a stored template. User actions and objects in the original collaboration sequence can be generalized automatically or manually. When a user selects a template to create a new collaboration space, the system populates the new space and defines a workflow for sequencing the use of the space. Thus, the template can include not only the structure and objects in the collaboration space, but can also include processes within the collaboration space. Some example uses of templates include trading, bidding, purchasing, contract negotiation, and so forth.

Further, users can migrate current or stored sessions to different collaboration spaces. Users start a collaboration space in one collaboration environment, such as Google Wave. In the middle of a session, the users want to migrate to another environment with a 3D world model, such as Second Life, to discuss certain aspects. The system can move all or some of the participants from the Google Wave environment to another nested session in Second Life while maintaining the context for an indefinite period. When the need for the 3D world model is over, the users can migrate back to the original Google Wave environment. The two sessions can have different characteristics and sets of resources depending on what is available, the needs of the session or the users, and so forth. Other examples include environments with support for different multimedia content or modalities, special collaboration tools or applications, higher security, more network or system resources, shifting end-user devices (such as a high-definition computer client to a mobile client), and so forth. The system can transfer, move, and/or translate semantic information from one space to another, such as participant information (human participants and robots), document objects, session history, personal views, and so forth. Migration to different collaboration systems can entail translating existing resources to new resource types, as well as translating identifiers, external object references, and so forth in order to maintain a common organization that can be moved between collaboration environments. Users can initiate migration or the system can suggest migration based on an analysis of current, past, or planned future activities.

In one aspect, the original collaboration space persists during the migration, even if all the participants have migrated to the new collaboration space. The system can migrate sessions by copying all or part of the information in one collaboration space, moving that information to the new environment, and connecting some or all of the participants to the new environment. In some cases, certain users may not be able to migrate to the new collaboration space due to permissions, device limitations, or other causes. The system can provide a gateway or translator for these users to bridge the two collaboration spaces. As users who have not yet migrated are able to migrate to the new collaboration space, the system can automatically transition them into the new collaboration space. Users can be in more than one collaboration space or collaboration environment at a time. The system can coordinate user placement in the new collaboration space to accurately reflect, to the extent possible, the configuration in the former collaboration space, such as original roles and content organization. Session migrations can be based on participant consensus or can be host controlled. Migration can occur on a continuous basis as an alternate embodiment to roaming style migration.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of communicating via a multi-model collaboration space, the method comprising:
assigning a communication endpoint identifier to a collaboration space comprising at least one entity;
receiving an incoming communication addressed to the communication endpoint identifier; and
transferring the incoming communication to at least one entity in the multi-model collaboration space.

2. The method of claim 1, wherein the multi-model collaboration space provides a shared persistent container in which entities can perform collaboration activities.

3. The method of claim 1, wherein each entity of the at least one entity has a unique identity.

4. The method of claim 1, wherein one of the at least one entity comprises a non-human, system-owned entity.

5. The method of claim 1, wherein each entity of the at least one entity has an individual view of the multi-model collaboration space based on an entity-specific dynamic context.

6. The method of claim 5, wherein the individual view is shareable with another entity.

7. The method of claim 1, wherein the endpoint identifier comprises at least one of a telephone number, an email address, an IP address, and a username.

8. The method of claim 1, wherein the incoming communication is a call from a user.

9. The method of claim 1, wherein the multi-model collaboration space is represented with a resource dimension, a time dimension, and a semantic dimension.

10. The method of claim 1, wherein the multi-model collaboration space further comprises shared resources.

11. The method of claim 10, wherein the shared resources comprise at least one of a document, an image, an application, and a database.

12. The method of claim 1, wherein the multi-model collaboration space further comprises a session representing a collection of collaboration activities between entities and resources, wherein the session spans a certain period of time, contains a specific set of semantic information, and contains specific resources.

13. The method of claim 12, wherein the session further comprises a nested session representing a nested collection of collaboration activities between entities and resource within the session.

14. The method of claim 1, wherein the multi-model collaboration space is an enterprise collaboration space.

15. The method of claim 1, further comprising:
saving information describing at least part of a current state of the collaboration space as a collaboration space template; and
generating a new collaboration space based on the collaboration space template.

16. The method of claim 1, wherein the multi-model collaboration space further comprises a recording component which stores a history of collaboration activity within the multi-model collaboration space.

17. The method of claim 16, wherein the history of collaboration activity comprises at least one of semantic time markers and layered time relationships.

18. A system for communicating via a multi-model collaboration space, the system comprising:
a processor;
a first module configured to control the processor to assign an communication endpoint identifier to a multi-model collaboration space comprising at least one entity;
a second module configured to control the processor to receive an incoming communication addressed to the communication endpoint identifier; and
a third module configured to control the processor to transfer the incoming communication to at least one entity in the multi-model collaboration space.

19. A non-transitory computer-readable storage medium storing instructions which, when executed by a computing device, cause the computing device to communicate via a multi-model collaboration space, the instructions comprising:
assigning an communication endpoint identifier to a multi-model collaboration space comprising at least one entity;
receiving an incoming communication addressed to the communication endpoint identifier; and
transferring the incoming communication to at least one entity in the multi-model collaboration space.

20. The non-transitory computer-readable storage medium of claim 19, wherein the multi-model collaboration space provides a shared persistent container in which entities can perform collaboration activities.
